(19) United States
(12) Patent Application Publication
(10) Pub. No.: US 2015/0185526 A1
(43) Pub. Date: Jul. 2, 2015

(54) LAMINATION CARRIER AND LAMINATION METHOD USING THE SAME

(71) Applicant: Wistron Corporation, New Taipei City (TW)

(72) Inventors: Sheng-Xiong Wu, New Taipei City (TW); Sheng-Kai Wang, New Taipei City (TW); Hung-Huei Hsu, New Taipei City (TW); Wu-Ling Pan, New Taipei City (TW)

(21) Appl. No.: 14/340,516

(22) Filed: Jul. 24, 2014

(30) Foreign Application Priority Data
Dec. 27, 2013 (CN) 201310738295.8

(51) Int. Cl. G02F 1/1333; B32B 38/00; B32B 37/18; B32B 37/06; B32B 37/00

(52) U.S. Cl. CPC G02F 1/13338; B32B 37/06; B32B 37/0046; B32B 37/18; B32B 38/0008; G02F 2202/28; B32B 2457/20

(57) ABSTRACT

A lamination carrier is used in a lamination method of a display device. The display device includes a first component, a second component and an adhesive layer. The first component includes a transparent portion and an opaque portion surrounding the transparent portion. The adhesive layer is disposed between the first component and the second component, and is distributed on the transparent portion and the opaque portion. The lamination carrier includes a base plate and a light-guiding structure having a reflecting surface that extends upwardly and outwardly from the base plate and that is disposed to reflect light to the adhesive layer distributed on the opaque portion of the first component. A lamination method is also disclosed.

### CROSS-REFERENCE TO RELATED APPLICATION

This application claims priority of Chinese Patent Application No. 201310738295.8, filed on Dec. 27, 2013, the entire disclosure of which is hereby incorporated by reference.

### BACKGROUND

1. Field

This disclosure relates to a lamination carrier and a lamination method using the same, more particularly to a lamination carrier used in a lamination method of a display device and a method for making a display device.

2. Description of the Related Art

A conventional touch type liquid crystal display usually includes several components, such as a touch panel, a liquid-crystal module, a back-light module. During manufacturing, the touch panel and the liquid-crystal module will be adhered to each other using an adhering medium, e.g., an optical clear adhesive (OCA), an optical clear resin (OCR), and so on.

FIG. 1 is a schematic view showing a conventional lamination process to form a display device 91 using a light source 92. The display device 91 includes a touch panel 93, a liquid-crystal module 94, an adhesive layer 95 and a sealant 96. The touch panel 93 has a transparent portion 931 and an opaque portion 932 surrounding the transparent portion 931. The transparent portion 931 includes a glass substrate, a transparent touch electrode, etc. (not shown), and has a relatively better light transmittance than the opaque portion 932. The opaque portion 932 includes a glass substrate, a high density of connecting wires, etc. (not shown), and is usually formed with a decorative ink layer at a position adjacent to a surface of the opaque portion 932. Therefore, light cannot penetrate the opaque portion 932 of the touch panel 93. The adhesive layer 95 (such as the abovementioned optical clear resin) and the sealant 96 are filled between the touch panel 93 and the liquid-crystal module 94, and are irradiated and cured by light (e.g., ultraviolet light) to provide adhesion effect.

In general, the lamination process for the display device 91 is conducted under a light source 92. When light (e.g., ultraviolet light) emitted by the light source 92 travels downwardly to the display device 91, a first portion of the light (L1) penetrates the transparent portion 931 and illuminates the adhesive layer 95 distributed on the transparent portion 931. The adhesive layer 95 distributed on the transparent portion 931 thus performs a photo-curing reaction so as to adhere the touch panel 93 and the liquid-crystal module 94 together. On the other hand, a second portion of the light (L2) is shielded by the opaque portion 932 so that the sealant 96 and the adhesive layer 95 distributed on the opaque portion 932 cannot be irradiated with a sufficient amount of light, and therefore are not completely cured after the lamination process. As such, an overflow 97 of the sealant 96 and/or the adhesive layer 95 is likely to take place, thereby adversely affecting the production yield of the display device 91.

In order to solve the overflow problem, there is provided a two-step lamination process. To be specific, a first curing step is conducted to cure the adhesive layer 95 distributed on the transparent portion 931 by virtue of the light source 92 (hereinafter referred to as a top light source) positioned above the display device 91, followed by a second curing step of curing the sealant 96 and the adhesive layer 95 distributed on the opaque portion 932 by virtue of another light source (not shown, hereinafter referred to as a lateral light source) positioned at one side of the display device 91. In this two-step lamination process, the top light source 92 and lateral light source are separately provided, so that the adhesive layer 95 and the sealant 96 can be irradiated with a sufficient amount of light. Therefore, the overflow problem for the sealant 96 and the adhesive layer 95 distributed on the opaque portion 932 can be avoided. However, since such two-step lamination process is usually performed by two different lamination devices (one has the top light source and the other has the lateral light source), the cost is relatively high and the manufacturing time is relatively long, thereby adversely affecting manufacturing efficiency.

### SUMMARY OF THE DISCLOSURE

Therefore, the object of the present disclosure is to provide a lamination carrier that is adapted to cooperate with a lamination device to ensure that light can illuminate simultaneously to top and lateral side of a display device. Hence, an overflow problem can be avoided, the yield and the efficiency of the manufacture can be improved, and the manufacturing cost can be reduced.

According to one aspect of the present disclosure, there is provided a lamination carrier adapted to be used together with a light source in a lamination method of a display device. The display device includes a first component, a second component and at least one adhesive layer. The first component includes a transparent portion and an opaque portion surrounding the transparent portion. The adhesive layer is disposed between the first component and the second component, and is distributed on the transparent portion and the opaque portion of the first component. The lamination carrier includes a base plate, and a light-guiding structure having at least one reflecting surface that extends upwardly and outwardly from the base plate and that is disposed to reflect light from the light source to the adhesive layer distributed on the opaque portion of the first component.

According to another aspect of the present disclosure, there is provided a lamination method for making a display device using the lamination carrier and a lamination device that includes the light source. The lamination method includes the steps of:
(a) preparing the display device;
(b) disposing the display device on the base plate of the lamination carrier in such a manner that the first component faces upwardly and that the adhesive layer at the opaque portion faces the reflecting surface of the light-guiding structure of the lamination carrier; and
(c) disposing the lamination carrier together with the display device under the light source and irradiating the adhesive layer with the light from the light source such that a portion of the light penetrates through the transparent portion to cure the adhesive layer distributed on the transparent potion, and such that another portion of the light is directed to and reflected by the reflecting surface toward the adhesive layer distributed on the opaque portion so as to cure the adhesive layer distributed on the opaque portion.

### BRIEF DESCRIPTION OF THE DRAWINGS

Other features and advantages of the present disclosure will become apparent in the following detailed description of the embodiments of this disclosure, with reference to the accompanying drawings, in which:

FIG. 1 is a fragmentary schematic side view showing a conventional lamination process to form a display device;

FIG. 2 is a schematic view showing the first embodiment of a lamination carrier according to this disclosure on which a display device is disposed;

FIG. 3 is a top view of the first embodiment and the display device;

FIG. 4 is a fragmentary schematic view showing the first embodiment and the display device that are disposed and transported on a conveying belt of a lamination device;

FIG. 5 is a flowchart showing the embodiment of a lamination method using the lamination carrier according to this disclosure;

FIG. 6 is a fragmentary schematic view showing the second embodiment of a lamination carrier according to this disclosure in use; and

FIG. 7 is a fragmentary schematic view showing the third embodiment of a lamination carrier according to this disclosure in use.

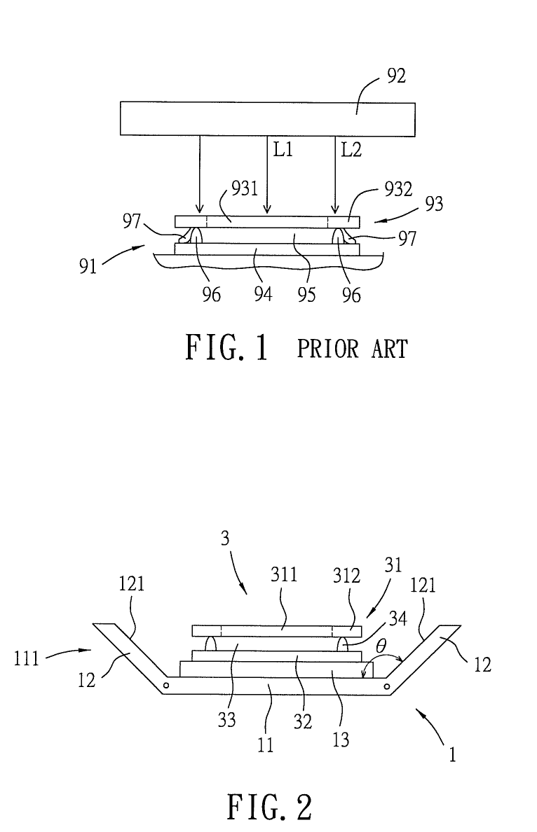

### DETAILED DESCRIPTION OF THE EMBODIMENTS

Before the present disclosure is described in greater detail, it should be noted that like elements are denoted by the same reference numerals throughout the disclosure.

### First Embodiment

Referring to FIGS. 2 to 4, the first embodiment of a lamination carrier 1 according to the present disclosure is used together with a lamination device 2 to perform a lamination method of a display device 3.

The structure of the lamination carrier 1 will now be depicted. The lamination carrier 1 includes a base plate 11, a light-guiding structure 111 and a pad 13 disposed on the base plate 11.

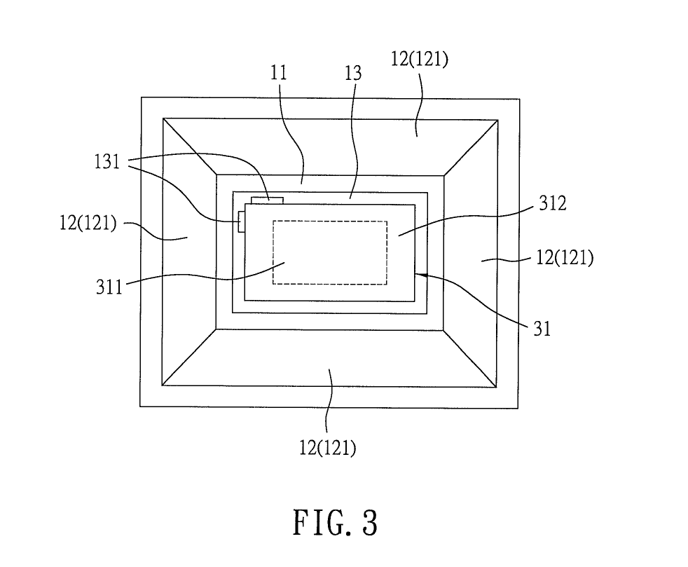

In this embodiment, the base plate 11 is rectangular in shape in order to cooperate with the shape of the display device 3. The light-guiding structure 111 includes four lateral plates 12 that respectively extend upwardly and outwardly from four lateral edges of the base plate 11. The light-guiding structure 111 has four reflecting surfaces 121. It is noted that for simplicity of illustration, only two lateral plates 12 and two reflecting surfaces 121 are illustrated in the drawings other than FIG. 3. Each of the reflecting surfaces 121 is formed on an inner side of a respective one of the lateral plates 12 so that the reflecting surfaces 121 extend upwardly and outwardly from the base plate 11. Each of the reflecting surfaces 121 is inclined with respect to the base plate 11 at an angle (θ) (θ is 135 degrees in this embodiment). Preferably, the lateral plates 12 are respectively adjustably connected to the base plate 11 such that inclination of the reflecting surfaces 121 relative to the base plate 11 (i.e., the angle (θ)) in adjustable. In this embodiment, the angle (θ) can be designed to be greater than 90 degrees and smaller than 180 degrees. By virtue of adjusting the angle (θ) between the base plate 11 and the reflecting surfaces 121, light reflected by the reflecting surfaces 121 can travel to a lateral side of the display device 3 to facilitate performance of the lamination method of the display device 3. However, the configurations of the base plate 11, the lateral plates 12 and the reflecting surfaces 121 can be adjusted in different embodiments based on actual requirements. For example, the shape of the base plate 11 could be any shape, the angle (A) may vary along the reflecting surfaces 121, and the lateral plates 12 may only be provided at some of the all lateral edges of the base plate 11.

The pad 13 of the lamination carrier 1 is used for disposing the display device 3 thereon. By virtue of the thickness of the pad 13, the altitude of the display device 3 with respect to the base plate 11 of the lamination carrier 1 can be adjusted such that each of the reflecting surfaces 121 face the lateral side of the display device 3. Moreover, during performance of the lamination method of the display device 3, the temperature of the base plate 11 may increase due to irradiation with the light with high energy. In order to avoid damage to the display device 3 attributed to the high temperature of the base plate 11, the pad 13 is preferably made of a thermal insulation material.

Further, in this embodiment, the pad 13 includes two elongated positioning elements 131 that are disposed at a periphery of a top surface of the pad 13. Extension directions of the two positioning elements 131 are perpendicular to each other. An outer edge of the display device 3 abuts against the positioning elements 131 so as to position the display device 3 on the pad 13 of the lamination carrier 1. However, the number and the location of the positioning elements 131 may vary in different embodiments to meet actual requirements. It is understood that the abovementioned description is only an example and should not be taken as a limitation for the positioning elements 131 of this disclosure.

It should be noted that, although the lamination carrier 1 of this embodiment is designed to include the pad 13, the pad 13 can be dispensed with depending on actual requirements. On the other hand, in this embodiment, the whole or a part of the lamination carrier 1 is made of high reflective material. Alternatively, a surface of the whole or a part of the lamination carrier 1 is covered by a high reflectivity layer.

The structure of the lamination device 2 and the display device 3 will now be illustrated.

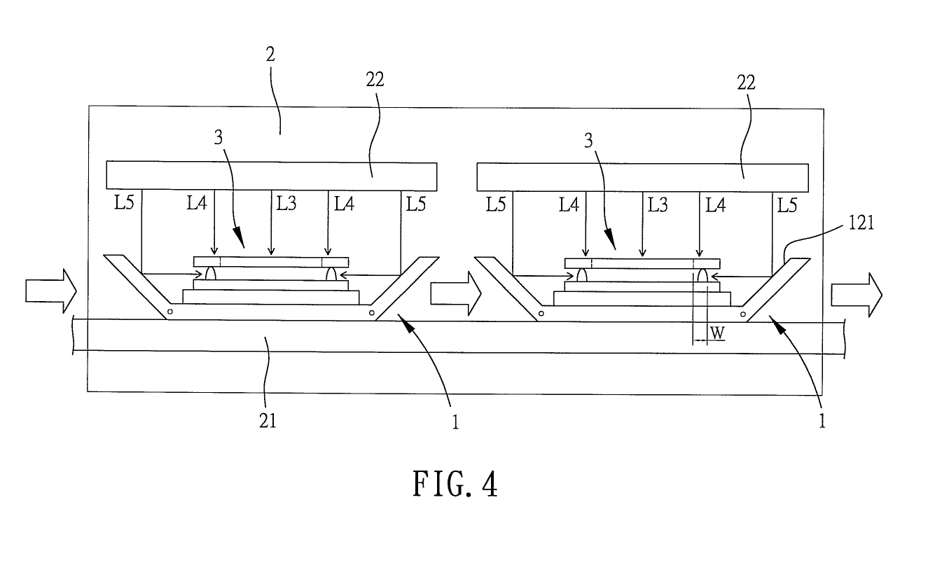

The lamination device 2 includes a conveying belt 21 and a plurality of light sources 22. The lamination carrier 1 along with the display device 3 is disposed on the conveying belt 21 and transported by the conveying belt 21 through a radiation zone where light of the light sources 22 illuminates. The conveying belt 21 has a feed end (left side in FIG. 4) and a discharge end (right side in FIG. 4). The design of the conveying belt 21 allows a lamination method to be performed continuously. The light sources 22 are disposed over the conveying belt 21 and emit the light (such as ultraviolet light) to the conveying belt 21 to provide light required in the lamination method. However, in other embodiments, the lamination device 2 can also be designed without the conveying belt 21. That is, the lamination device 2 is designed to merely have the light sources 22, and such lamination device 2 can also be used to perform the lamination method.

The display device 3 includes a first component 31, a second component 32, a first adhesive layer 33 and a second adhesive layer 34. The first component 31 (such as a touch panel) includes a transparent portion 311 and an opaque portion 312 surrounding the transparent portion 311. A major component in the transparent portion 311 is a transparent structure (such as a transparent touch electrode), and thus, the transparent portion 311 has a better light transmittance than the opaque portion 312. A major component in the opaque portion 312 is an opaque structure (such as a decorative ink layer), and thus light is unlikely to penetrate through the opaque portion 312. The second component 32 (such as a liquid-crystal module) is connected with the first component 31 through the first adhesive layer 33 and the second adhesive layer 34. The first adhesive layer 33 (such as an OCR) is disposed between the first component 31 and the second component 32, is distributed on the transparent portion 311 and the opaque portion 312 of the first component 31, and can be cured after being irradiated by light, thereby providing adhesion effect. The second adhesive layer 34 (such as a sealant) is disposed mainly on the opaque portion 312, surrounds the first adhesive layer 33, and can also be cured after being irradiated by light. Before curing, the second adhesive layer 34 has a viscosity coefficient higher than that of the first adhesive layer 33. Therefore, by virtue of surrounding the first adhesive layer 33 with the second adhesive layer 34 that has a higher viscosity coefficient, the situation that the first adhesive layer 33, which has a lower viscosity coefficient, flows out between the first component 31 and the second component 32, can be avoided.

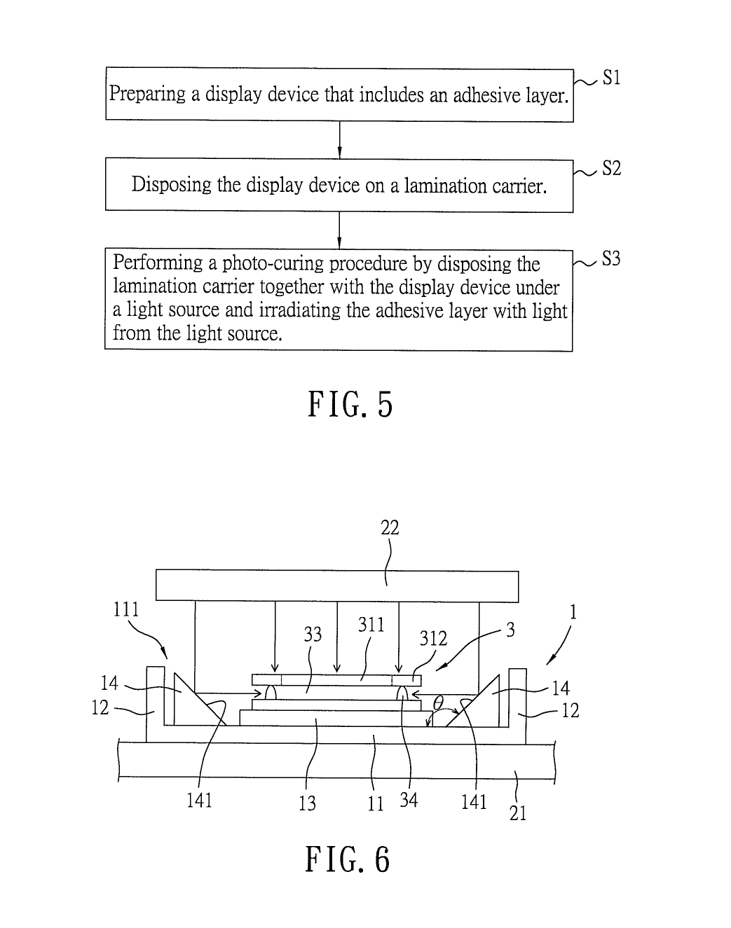

Referring to FIGS. 2, 4 and 5, a lamination method for making the display device 3 according to this disclosure includes the following steps.

Step S1: preparing the display device 3. For example, the first adhesive layer 33 and the second adhesive layer 34 are distributed on the second component 32, and then the first component 31 is aligned with and disposed on the second component 32 such that the first adhesive layer 33 and the second adhesive layer 34 are disposed between the first component 31 and the second component 32 so as to obtain the display device 3.

Step S2: disposing the display device 3 which is prepared by step S1 on the lamination carrier 1 to perform a subsequent photo-curing procedure. To be specific, in this step, the display device 3 is disposed on the pad 13 of the lamination carrier 1 in such a manner that the first component 31 faces upwardly and the first adhesive layer 33 and the second adhesive layer 34 distributed on the opaque portion 312 of the first component 31 faces the reflecting surfaces 121 of the light-guiding structure 111 of the lamination carrier 1. With such arrangement, the first adhesive layer 33 and the second adhesive layer 34 distributed on the opaque portion 312 can be subjected to a photo-curing reaction by virtue of the light emitted from the light sources 22 and reflected by the reflecting surfaces 121.

As mentioned above, prior to disposing the display device 3 on the lamination carrier 1, the thickness of the pad 13 as well as the angle (θ) between the reflecting surfaces 121 and the base plate 11 can be adjusted according to the size of the display device 3, thereby efficiently performing the subsequent photo-curing procedure.

Step S3: performing a photo-curing procedure. To be specific, the lamination carrier 1 together with the display device 3 is disposed on and transported by the conveying belt 21 under the light sources 22 to perform a photo-curing procedure. When the display device 3 is transported to a position under any one of the light sources 22, i.e., a radiation zone, the first adhesive layer 33 distributed on the transparent portion 311 is irradiated by the light from the light source 22 such that a portion of the light (L3) penetrates through the transparent portion 311 to cure the first adhesive layer 33 on the transparent potion 311. That is, the first adhesive layer 33 on the transparent potion 311 is irradiated by the portion of the light (L3) directly emitted from the light source 22. On the other hand, a portion of the light (L4) is shielded by the opaque portion 312 and therefore cannot directly illuminate the first adhesive layer 33 and the second adhesive layer 34 distributed on the opaque portion 312. However, a portion of the light (L5) is directed to and reflected by the reflecting surfaces 121 toward the first adhesive layer 33 and the second adhesive layer 34 distributed on the opaque portion 312 so as to perform a photo-curing procedure. As such, by virtue of cooperation of the lamination carrier 1 and the lamination device 2, when performing the lamination method, the top (i.e., a top side of the first component 31) and the lateral side of the display device 3 can be irradiated by a sufficient amount of light such that the photo-curing procedure of the first adhesive layer 33 and the second adhesive layer 34 can be performed completely. Therefore, the overflow problem caused by incomplete curing can be avoided.

In the photo-curing procedure described in step S3, the speed of the conveying belt 21 that transports the lamination carrier 1 together with the display device 3 will affect the irradiating time of the first adhesive layer 33 and the second adhesive layer 34. An energy density per time of the light emitted from any light source 22 will affect the total amount of energy received by the first adhesive layer 33 and the second adhesive layer 34. Therefore, before performing step S3, the speed of the conveying belt 21 and the energy density per time of the light should be properly set according to the specifications of the display device 3, specifically of the first adhesive layer 33 and the second adhesive layer 34, so as to control an overall irradiating time and the total energy density of the light received by the first adhesive layer 33 and the second adhesive layer 34. Preferably, according to different operating environments and conditions, the abovementioned factors can be set as below: the speed of the conveying belt 21 is set to range from 2 to 3 m/min (i.e., the lamination carrier 1 together with the display device 3 are transported through the radiation zone at a speed ranging from 2 to 3 m/min); the energy density per time of the light emitted from the light source 22 is set to range from 55 to 83 mJ/(cm²·sec); the total energy density received by the first adhesive layer 33 and the second adhesive layer 34 is set to range from 1600 to 2400 mJ/cm²; and the total irradiating time is set to range from 36 to 54 seconds. Under such conditions, irradiation of the first adhesive layer 33 and the second adhesive layer 34 on the opaque portion 312 with the portion of the light (L5) reflected by the reflecting surfaces 121 could ensure complete curing of the first adhesive layer 33 and the second adhesive layer 34 on the opaque portion 312 and in turn, effective bonding between the first component 31 and the second component 32. In the lamination method according to the present disclosure, curing of portions of the first and second adhesive layers 33, 34 is ensured within a 5 mm range (W) from a boundary of the second adhesive layer 34 remote from the first adhesive layer 33 (see FIG. 4), thereby solving the overflow problem.

### Second Embodiment

FIG. 6 illustrates the second embodiment of a lamination carrier 1 according to this disclosure. The lamination carrier 1 has a structure similar to that of the first embodiment, except that the light-guiding structure 111 includes four of the reflecting surfaces 141 and four reflectors 14 that are disposed on the base plate 11 and that are respectively formed with the reflecting surfaces 141. Moreover, the lateral plates 12 are different in arrangement from that of the first embodiment (i.e., the lateral plates 12 are perpendicular to the base plate 11) and are not formed with the reflecting surfaces 121.

Specifically, in this embodiment, the portion of the light (L5) is directed to and reflected by the reflecting surfaces 141 formed on the reflectors 14 toward the lateral side of the display device 3, i.e., toward the first adhesive layer 33 and the second adhesive layer 34 on the opaque portion 312. Accordingly, in the photo-curing procedure, cooperation of the lamination carrier 1 with the light source 22 could direct the light to the top and the lateral side of the display device 3, thereby performing the lamination method precisely.

Similar to the first embodiment, the angle (θ) between the reflecting surfaces 141 of the reflector 14 and the base plate 11 can also be adjustable. For example, in this embodiment, the reflectors 14 are movably and detachably disposed on the base plate 11. Therefore, the arrangement of the reflectors 14 can be adjusted in order to adjust the inclination of the reflecting surfaces 141 relative to the base plate 11 (i.e., the angle (θ)). Moreover, each of the reflecting surfaces 141 may have a different inclined angle (θ) with respect to the base plate 11. That is, a suitable reflector 14 can be chosen according to actual requirements. However, the way to adjust the inclined angle (θ) between the reflecting surfaces 141 and the base plate 11 may vary in different embodiments as long as the desired effect to be achieved by the reflecting surfaces 141 can be accomplished. Therefore, the abovementioned method is an example and should not be taken as a limitation of this disclosure.

### Third Embodiment

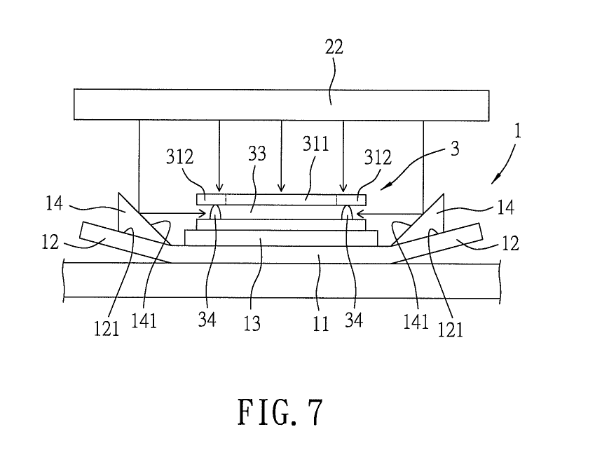

FIG. 7 illustrates the third embodiment of a lamination carrier 1 according to this disclosure. The lamination carrier 1 has a structure similar to that of the second embodiment, except that the lateral plates 12 are designed to respectively extend outwardly and upwardly from the lateral edges of the base plate 11 and to be respectively formed with reflecting surfaces 121 (i.e., each of the lateral plates 12 has a structure and arrangement similar to those of first embodiment), and that the reflectors 14 are respectively disposed movably and detachably on the lateral plates 12. In this embodiment, since the lateral plates 12 are higher than the base plate 11 in a vertical direction, disposing the reflectors 14 on the lateral plates 12 creates a better ability to adjust the altitude of the reflecting surfaces 141 in comparison with disposing the reflectors 14 on the base plate 11. However, it is noted that, disposition of the reflectors 14 on the base plate 12 is also permissible and can also achieve the advantage of this disclosure.

To sum up, the lamination carrier 1 according to this disclosure is able to reflect the light from the light sources 22 toward the lateral side of the display device 3 to compensate the drawback associated with the prior art (i.e., the light source 22 only emits the light toward the top of the display device 3). As such, the first adhesive layer 33 and the second adhesive layer 34 can be simultaneously irradiated with the light from the top and the lateral side of the display device 3. Therefore, the first adhesive layer 33 and the second adhesive layer 34 can be cured certainly so as to avoid overflow problem, and the first component 31 and the second component 32 can be securely adhered to each other, thereby improving production yield. The lamination method according to this disclosure includes a one-step curing procedure, and the display device 3 is not required to be subjected to two-step irradiating procedure. Therefore, the manufacturing time can be reduced and the production efficiency can be increased. Furthermore, there is no need to purchase the lateral light source so that the manufacturing cost can be decreased effectively. As a result, the objects of the present disclosure can be accomplished.

While the present disclosure has been described in connection with what are considered the most practical embodiments, it is understood that this disclosure is not limited to the disclosed embodiments but is intended to cover various arrangements included within the spirit and scope of the broadest interpretation and equivalent arrangements.

What is claimed is:

1. A lamination carrier adapted to be used together with a light source in a lamination method of a display device, the display device including a first component, a second component and at least one adhesive layer, the first component including a transparent portion and an opaque portion that surrounds the transparent portion, the adhesive layer being disposed between the first component and the second component, and being distributed on the transparent portion and the opaque portion of the first component, said lamination carrier comprising:
a base plate; and
a light-guiding structure having at least one reflecting surface that extends upwardly and outwardly from said base plate and that is disposed to reflect light from the light source to the adhesive layer distributed on the opaque portion of the first component.

2. The lamination carrier as claimed in claim 1, wherein inclination of said reflecting surface relative to said base plate in adjustable.

3. The lamination carrier as claimed in claim 1 or 2, wherein said reflecting surface is inclined with respect to said base plate at an angle greater than 90 degrees and smaller than 180 degrees.

4. The lamination carrier as claimed in claim 1, wherein:
said light-guiding structure includes at least one lateral plate extending upwardly from said base plate and formed with said reflecting surface.

5. The lamination carrier as claimed in claim 4, wherein said base plate is substantially rectangular in shape, said light-guiding structure having four of said reflecting surfaces and including four of said lateral plates that extend upwardly and respectively from four lateral edges of said base plate and that are respectively formed with said reflecting surfaces.

6. The lamination carrier as claimed in claim 1, wherein said light-guiding structure includes at least one reflector disposed on said base plate and formed with said reflecting surface.

7. The lamination carrier as claimed in claim 1, wherein said light-guiding structure has two of said reflecting surfaces and includes at least one lateral plate that extends upwardly from said base plate, and at least one reflector that is movably and detachably disposed on said lateral plate, said reflector and said lateral plate being respectively formed with said reflecting surfaces.

8. The lamination carrier as claimed in claim 1, wherein said light-guiding structure has two of said reflecting surfaces and includes at least one lateral plate that extends upwardly from said base plate, and at least one reflector that is movably and detachably disposed on said base plate, said reflector and said lateral plate being respectively formed with said reflecting surfaces.

9. The lamination carrier as claimed in claim 1, further comprising a pad disposed on said base plate, the display device being adapted to be mounted on said pad such that said reflecting surface faces the adhesive layer on the opaque portion.

10. The lamination carrier as claimed in claim 9, wherein said pad includes at least one positioning element, the display device abutting against said positioning element so as to be positioned on said pad.

11. The lamination carrier as claimed in claim 9, wherein said pad is made of thermal insulation material.

12. A lamination method for making a display device using the lamination carrier as claimed in claim 1 and a lamination device including the light source, the lamination method comprising the steps of:
(a) preparing the display device;
(b) disposing the display device on the base plate of the lamination carrier in such a manner that the first component faces upwardly and the adhesive layer at the opaque portion faces the reflecting surface of the light-guiding structure of the lamination carrier; and
(c) disposing the lamination carrier together with the display device under the light source and irradiating the adhesive layer with the light from the light source such that a portion of the light penetrates through the transparent portion to cure the adhesive layer distributed on the transparent potion, and a portion of the light is directed to and reflected by the reflecting surface toward the adhesive layer distributed on the opaque portion so as to cure the adhesive layer distributed on the opaque portion.

13. The lamination method as claimed in claim 12, wherein, in step (c), the light has energy density per second ranging from 55 to 83 mJ/(cm²·sec).

14. The lamination method as claimed in claim 12, wherein, instep (c), the adhesive layer distributed on the opaque portion with total energy density ranging from 1600 to 2400 mJ/cm².

15. The lamination method as claimed in claim 12, wherein the lamination device includes a conveying belt disposed under the light source, the lamination carrier being disposed and transported on the conveying belt,
in step (c), the lamination carrier with the display device being transported by the conveying belt through a radiation zone where the light of the light source illuminates at a speed ranging from 2 to 3 m/min.

16. The lamination method as claimed in claim 12, wherein, in step (c), the adhesive layer is irradiated with the light for 36 to 54 seconds.
